(19) United States
(12) Patent Application Publication
(10) Pub. No.: US 2002/0003144 A1
(43) Pub. Date: Jan. 10, 2002

(54) Garbage can with removable bottom

(76) Inventor: David G. Grimes, Mobile, AL (US)

Correspondence Address: GREGORY M. FRIEDLANDER & ASSOCIATES, P.C., 11 SOUTH FLORIDA STREET, MOBILE, AL, 36606-1934, US

(21) Appl. No.: 09/900,284

(22) Filed: Jul. 6, 2001

Related U.S. Application Data
(60) Provisional application No. 60/216,756, filed on Jul. 7, 2000.
(60) Provisional application No. 60/226,641, filed on Aug. 21, 2000.

(51) Int. Cl. B65D 6/28; B65D 8/04; B65D 8/06; B65F 1/00

(52) U.S. Cl. 220/625; 220/908

(57) ABSTRACT

A container for holding garbage comprising: an open cylinder having a left side and a right side; at least one strap attached to the back side of the cylinder; at least one attachment means on the front side of the cylinder for releasably holding the at least one strap to the front side of the cylinder; at least one opening from the exterior of the cylinder to the interior of the cylinder; at least one wheel attached to the cylinder to allow it to be moved. A bottom may be removable from the bottom of the cylinder held by the same straps.

### PRIORITY

This patent claims priority based on Provisional Patent Ser. No. 60/216,756 filed Jul. 7, 2000 and Provisional Patent Ser. No. 60/226,641 filed Aug. 21, 2000.

### BACKGROUND OF INVENTION

1. Field of the Invention

The invention relates to garbage cans. More particularly, the invention relates to garbage cans with removable bottoms. More particularly, the invention relates to garbage cans for the collection of leaves, yard debris and the like.

2. Prior Art

Different garbage cans, leaf collectors, various devices to receive leaves, clothes hampers and linen hampers are known in the prior art.

### GENERAL DISCUSSION OF THE INVENTION

The invention disclosed herein is a garbage can with a removable bottom. The round open, smooth wall cylinder of the garbage can is made of lightweight plastic or fiberglass with no top or bottom, for trash, leaf and lawn debris cans. The invention's open can cylinder body may come in a variety of different sizes. This allows the unit to accommodate the different size lawn, trash or linen bags being made by other manufactures. In the preferred embodiment the invention comes in two sizes. One is approximately 55 gallon in size, approximately 36″ in height and approximately 24″ in diameter. It holds a 55 gallon plastic yard or linen bag. The other one is approximately 35 gallon in size, approximately 28″ in height and approximately 20″ in diameter. It holds a 35 gallon plastic yard or linen bag.

The open bottom of the open can cylinder's body may be of slightly larger diameter than the open can cylinder's body's open top diameter. This allows one unit to fit over another unit. This in turn allows for consolidation of the units during manufacturing, shipping and storage. This also reduces the amount of display space required for each unit. It also allows loads to be discharged through the bottom.

The bottom of the invention may be as simple as cross straps of webbing. If cross straps are used, they should be sufficiently thick and wide enough so that they can support the weight of the contents in the cylinder. Particularly, if a bag is used, the weight of the contents against the bottom should not tear the bag.

In the preferred embodiment, adjacent to the bottom, the can cylinder has two webbing cross straps, approximately 2″ in width and approximately 40″ in length, each permanently attached at one end to its wheel side or back side of its body by adhesive or molded into the cylinder body. In another embodiment, one webbing cross strap is attached to the right side and one is attached to the left side of the invention's back side. On the free end of each of these webbing cross straps, held in a straight position, underneath the body, on the side facing the cylinder, is a strip of fastening tape of interlocking hook and loop fasteners (VELCRO), approximately 2″ in width and approximately 10″ in length, sewn on or attached by adhesive to the webbing cross straps. This could be replaced with a buckle. The bottom may have aligning brackets through which the straps pass to keep them from slipping and tightly holding the bottom. This can also keep the straps off the ground so wear is reduced.

In the preferred embodiment the opposite side or front side of the can's body are two patches of cooperating loop fasteners to work with hooks in the straps, approximately 3″ in width and approximately 10″ in length. They are mounted permanently with adhesive or molded into the cylinder's body and cooperate with the interlocking hooks on the two webbing cross straps. These patches are located on the left and right lower portion of the invention's front side. When the hooks of the cooperating hook and loop fasteners on the two webbing cross straps are interlocked with these patches of loops on the front side, they support the bottom of a plastic yard or linen bag and its contents during the filling and moving of the invention.

Also, on the cylinder's body's left and right side is a patch of loop fasteners, approximately 3″ in width and approximately 10″ in length. They are mounted permanently with adhesive or molded into its body and cooperate with the Velcro hooks on the two webbing cross straps. These patches are located on the upper back portion of the invention's left and right sides. When the hooks of the hook and loop fasteners on the two webbing cross straps are interlocked with the loops on these two patches, the webbing cross straps are held out of the way during the emptying of the invention.

Exhaust or vent holes are provided in the sides of the open can cylinder's body to allow the garbage bag to expand outward when being filled and to prevent suction from holding it when the bag is removed. These holes are small smooth molded or drilled ventilation holes, approximately ½″ in diameter. These holes prevent a vacuum from forming and holding the bags within the cylinder defined herein.

There is a loose or independent elastic ring or strap, approximately 22″ in diameter that goes around the cylinder's top, preferably between a molded top lip and a molded bottom lip, which keeps the strap in place. This elastic ring or strap holds a garbage, yard or linen bag in an open position by securing the periphery to the outer circumference of the cylinder tip and ensures that the bag does not fall out or slip down during filling of the bag and moving of the cylinder.

The top and bottom lips mentioned above do not run around the entire open can cylinder's circumference in the preferred embodiment, but the lips may in alternate embodiments. This partial opening of the lips allows easy access to the elastic ring or strap by exposing it in the gaps to the user.

The invention preferably has one or more handles in order to allow it to be tilted, moved or lifted. These handles may be attached or made into the cylinder's body. One handle is on the wheel side or the back side of the cylinder and the other on the opposite or its front side. At least one second set of handles, lower down, may allow for easier lifting of the cylinder over the bag.

The invention preferably has two wheels, approximately 6″ in diameter, so that it may be rolled around, for example, to collect leaves or yard debris. These wheels may be attached to the cylinder in several different ways. These wheels on which the invention rolls also support the whole body in a level position. The wheels are preferably attached in such a way to allow the webbing cross straps to be undone, as by releasing Velcro-fastening tape hooks on the webbing cross straps from the patches of Velcro-fastening tape loops on its front side, which allows the cylinder to be tilted, rolled and emptied or lifted up to release what is contained in the body cylinder.

On some embodiments of the invention, lids may be provided to cover the open top of the cylinder's body. This is not to say or intend that lids will be provided or needed on all embodiments of the invention.

For safety to its user, all manufactured edges of the invention are smooth or dull to protect its user from cuts and abrasions. This also helps prevent cuts and tears to the plastic bags used in the invention.

In the preferred embodiment of the invention, the webbing cross straps are not supplemented with a removable base. The webbing cross straps can also be supplemented with swing open and close hinged plates held in place in a closed position by the webbing cross straps.

Thus, the webbing cross straps may be replaced with hinges and the bottom plate may be held in place by the hinge. Elastic straps in retaining holes may be used in place of Velcro. The webbing cross straps can also be replaced with a removable independent base which may be a cylinder, a base plate, which slides in or out of grooves in the bottom, a swing open and close door, a removable net or swing in and out hinged forks.

Also disclosed herein, is a means to allow a single user to lift the cylinder in the event that it is filled by having poles which may extend over this cylinder. A pulley system attached to the poles so that the can may be pulled approximately straight upward in order to lift it above a filled bag.

Some warnings which may be provided on the cylinder are:

Anytime plastic bags of any size or nature are used in this invention or its embodiments, caution should be used around children to prevent suffocation or drowning.

Anytime elastic rubber straps are used, caution should be used to prevent breakage and causing damage to the eyes.

Cross straps, their supplemented parts or their replacement parts may become a tripping hazard if not stored or used in their correct position.

Use proper lifting procedures when lifting and moving this invention or any of its various embodiments.

It is therefore an object of the invention to provide for a plastic garbage, yard or clothing bag to be held open, moved about and removed, holding its contents in a closed confined manner for the various purposes discussed above.

One purpose of the invention is to provide a safe, convenient and easy way to place garbage, leaves, yard debris, soiled clothing or the like in a portable, manageable apparatus. It is another purpose to provide the convenience of easy removal of contents from a garbage can. The contents may be a trash bag or cloth bag.

Another purpose is to eliminate the need for the user to lift heavy bags of leaves, yard debris or soiled clothing and linens.

Another purpose is to provide a gathering can which requires only one person to use and makes pick up of piles of leaves or yard debris easy. The user need only tilt the device and roll it from pile to pile. The device makes street or curb pick up of trash easy. The user need only roll to the curb and remove bag. The device makes transporting garbage, dirty clothing or linen easy.

For cosmetic reasons, it is suggested the preferred embodiment be green or forest green in color. The removable base may be a separate color to make it easily visible so it is not accidentally filled without a base.

These and other objects and advantages of the invention will become better understood hereinafter from a consideration of the specification with reference to the accompanying drawings forming part thereof, and in which like numerals correspond to parts throughout the several views of the invention.

### BRIEF DESCRIPTION OF DRAWINGS

For a further understanding of the nature and objects of the present invention, reference should be made to the following detailed description taken in conjunction with the accompanying drawings in which like parts are given like reference numerals and wherein:

FIG. 1 shows the invention's side view of the wheels or the left side of the invention.

FIG. 2 is a plain view showing the rear view of the wheels or the back side of the invention.

FIG. 3 shows the invention with a filled plastic garbage or yard bag in place.

FIG. 4 shows the invention's right side with a square body shape.

FIGS. 5 shows an alternate embodiment having secondary strap securing locations to hold the strap out of the way.

FIG. 6 shows an alternate embodiment having a hinged base.

FIG. 7 shows an alternate embodiment having clips and hooks to secure the base to the cylinder.

FIG. 8 shows an alternate embodiment having a base which slides on rails in contact with the base of the cylinder.

FIG. 9 shows an alternate embodiment having a bag retaining strap held between lips at the top of the cylinder.

FIG. 10 shows an alternate embodiment having a hinged side.

FIG. 11 shows an alternate embodiment having a net for a base.

FIG. 12 shows an alternate embodiment having clips and hooks to secure the base to the cylinder.

FIG. 13 shows a pulley lifting system used in conjunction with the embodiment shown in FIG. 14.

FIG. 14 shows an alternate embodiment having multiple handles and interior surface ridges.

FIG. 15 shows an alternate embodiment having a top support surface.

### DETAILED DESCRIPTION OF THE PREFERRED EXEMPLARY EMBODIMENTS

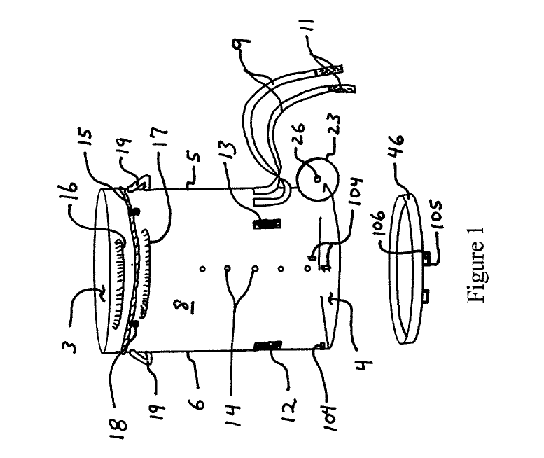

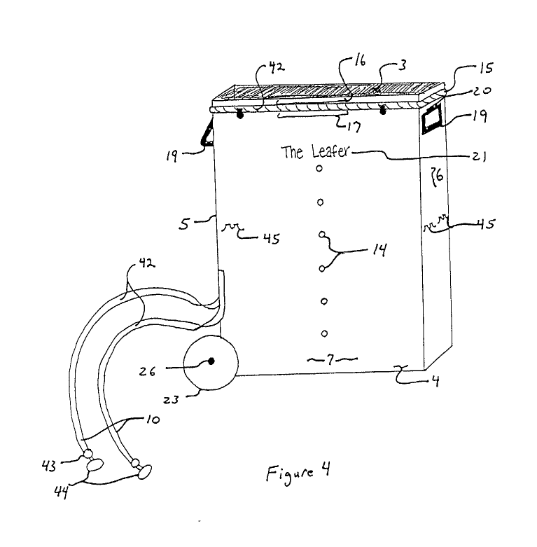

As best be seen by reference to FIG. 1, the preferred embodiment comprises an open can cylinder 1, which is cylindrical in design. Referred to as the body herein. The body also may be square in design 2, as shown in FIG. 4. It has an open top 3 and an open bottom 4. The side the wheels are mounted on is the wheel side or backside 5 of the invention. Opposite from the backside is the front side 6. Looking at the invention from its backside 5, it has a right side 7 and a left side 8.

It has two webbing cross straps 9 mounted permanently on its backside 5. These webbing cross straps 9 may be replaced with elastic cross straps 42 as shown on FIG. 4. Preferably these are on the back side and are mounted permanently at one end by adhesive or molded onto the body's backside 5, as shown in FIG. 4. The loose or free ends 10 of the webbing cross straps 9 have interlocking hooks 11. On the cylinder's front side 6, the cylinder has two patches of interlocking loops 12 which cooperate to make a releasable connection with the hooks 11 on the webbing cross strap's 9 loose ends 10 during filling and moving the invention around with a plastic garbage or yard bag 22 in place. At this time, the open bottom 4 is at least partially enclosed by the two cross straps 9 running underneath its open bottom 4.

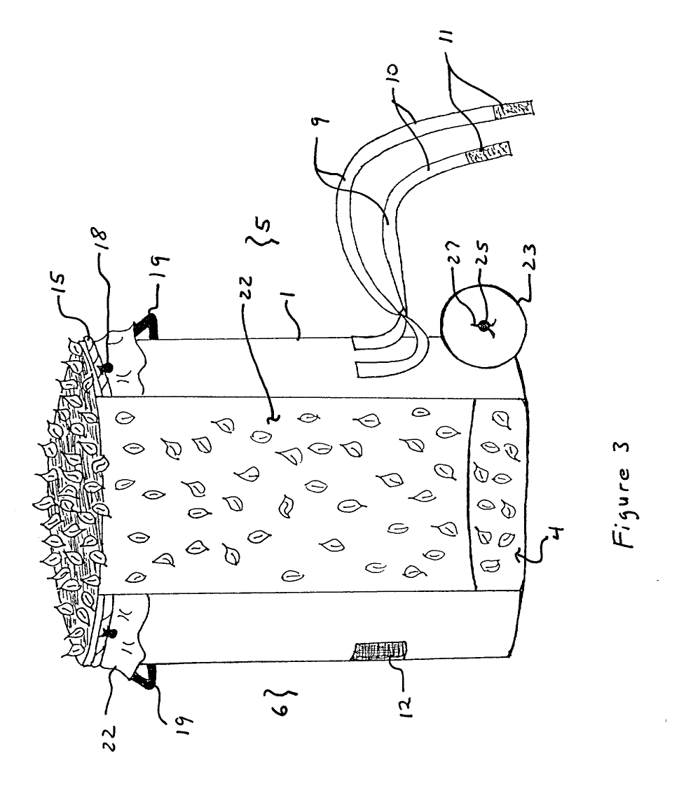

These webbing cross straps 9 may be replaced with rubber elastic straps 42 and the hooks 11 replaced with locking devices 43 located on the free ends 10 of the rubber elastic cross straps 42, as shown in FIG. 4. These elastic rubber cross straps 42 may also have finger tabs 44 located on their free ends 10, as shown in FIG. 4. If the webbing cross straps 9 are replaced with elastic rubber straps 42, the patches 12 of loops will be replaced with molded notched locking device receivers 45. These receivers 45 (here a u-shaped receiver) will cooperate with the locking device 43 (here a ball of rubber which fits within the u-shaped receiver) on the free ends 10 of the rubber elastic cross straps 42. A filled bag 22 can be seen in FIG. 3 showing a clear view of the interior.

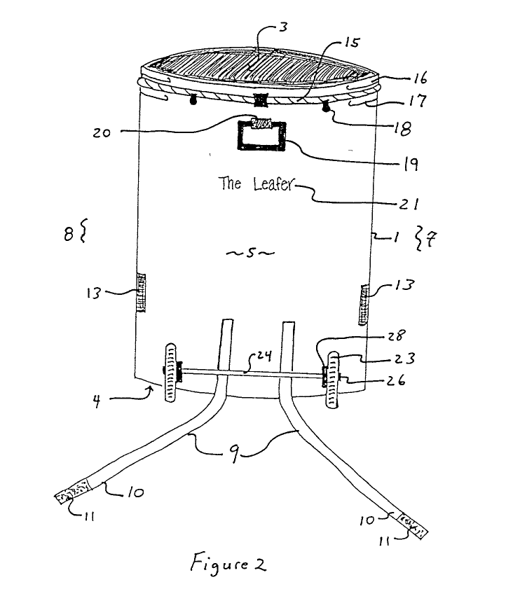

FIG. 2 shows another patch of loops 12 of Velcro type interlocking loops 13 are attached to the open can's body 1 on its right side 7 and the can's left side 8. These loops 13 cooperate with the hooks 11 on the cross straps 9, to hold the cross straps 9 out of the way during removal of the plastic bag 22.

If the webbing cross straps 9 are replaced with elastic rubber cross straps 42, these patches of loops 13 will be replaced with molded notched locking device receivers 45. These receivers 45 will cooperate with the locking device 43 on the free ends 10 of the rubber elastic cross straps 42, as shown in FIG. 4.

The invention's body 1 has small exhaust vent holes 14. These holes 14 allow air to be pushed from the body's 1 interior as the bag 22 is filled and air to return as the bag is removed. These holes 14 are shown in a straight line but may be located in various locations in various patterns. These holes 14 may not be shown on all embodiments but their placement and use are intended where applicable.

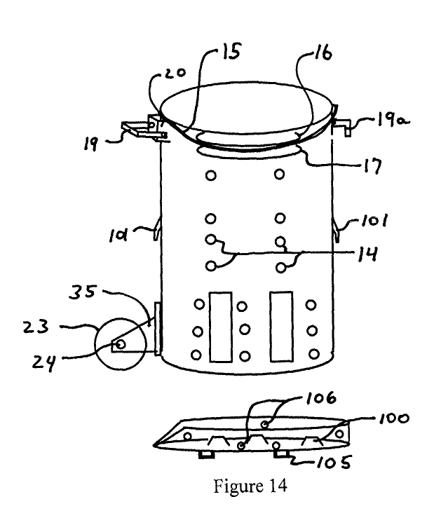

Channels formed by notches 100, as shown in FIG. 14, may aid or replace the holes 14 in allowing air to pass through the interior of the cylinder body.

An independent elastic retaining ring or strap 15 is placed near the open top 3. This ring 15 helps hold a plastic bag 22 in place. The ring 15 itself is held in place by a top lip 16 and a bottom lip 17. The ring 15 may have finger tabs 18 for gripping to allow easy access and control of the ring 15 during its placement or removal. The ring 15 and lips 16 and 17 are shown in FIG. 14.

To accommodate lifting, tilting and moving the invention, plastic handles 19 are attached to the body 1 by molded plastic handle supports or retainers 20 at its open top. Handles 19 are not shown on all embodiments but their placement and use are intended where applicable. As shown on FIG. 14, at least one lower set of handles 101 may be used to aid the user in lifting the can off the bag when the base 46 is removed. This second set of handles 101 may be molded close to the side of the container so that they do not interfere with stacking. They may be designed to pivot out in use to be easier to grip.

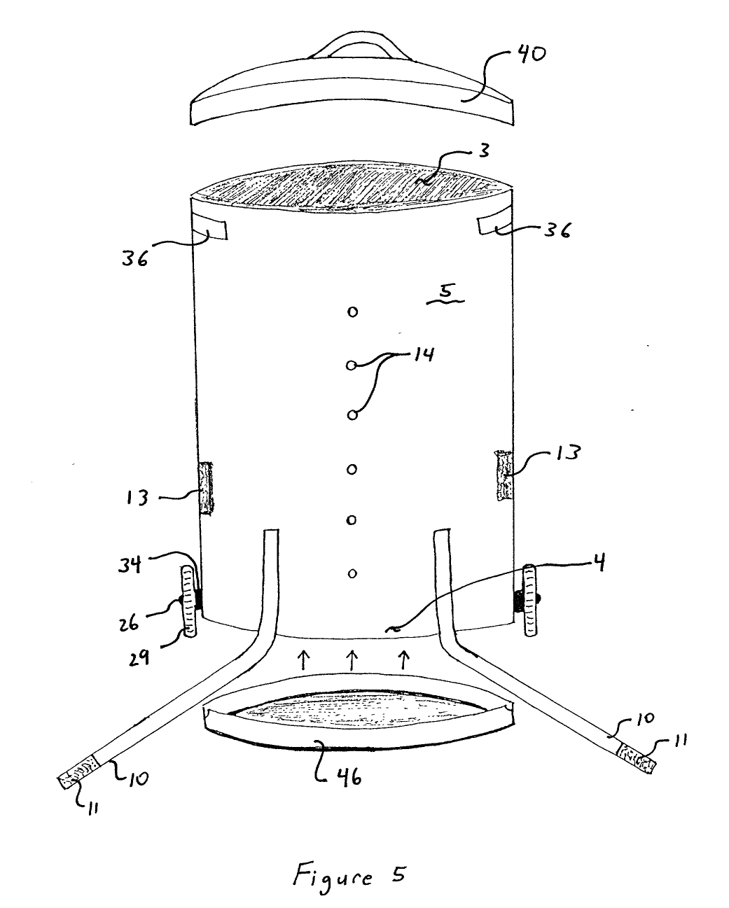

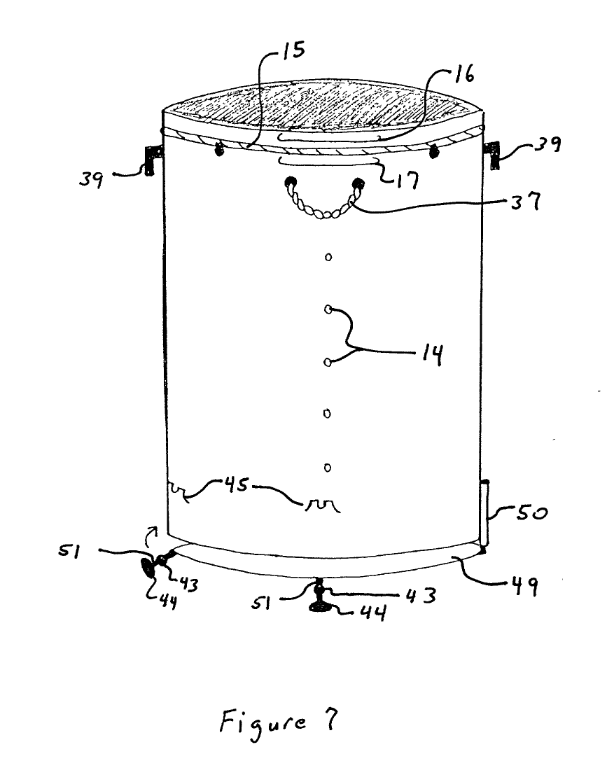

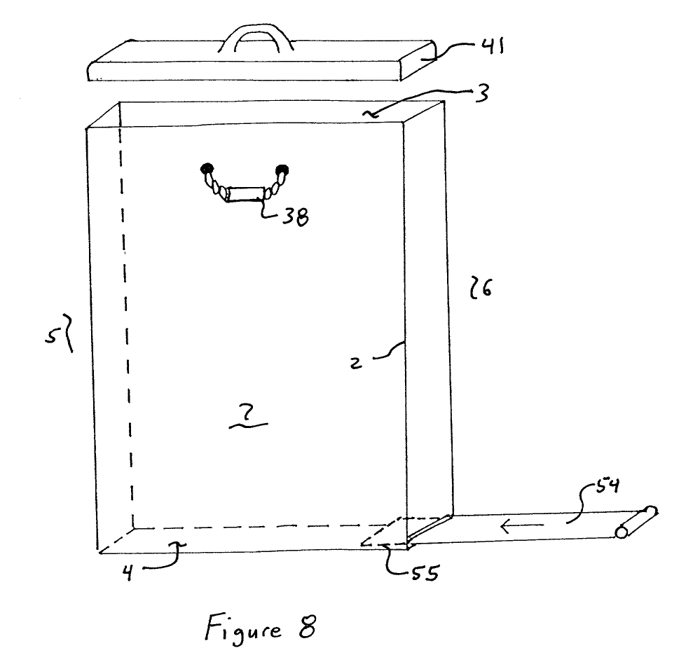

Other types of handles may be used on the invention and its various embodiments. Handles may be as simple as smooth cut slots 36 shown in FIG. 5. Another simple handle method is handles made of rope or rope like materials 37, as shown in FIG. 7. These handles 37 are used with rope attached to the body 1 with knots tied on the rope's ends within the body's 1 interior forming the rope handles 37. These rope handles 37 may also run through pieces of PVC pipe 38 to ease hand strain, as shown in FIG. 8. The latter discussed lifting device downward shaped hook handles 39 may be used on the body 1, as shown in FIG. 7, so that the loops or rings 32 will have something to attach to or lift by, as shown in FIG. 7. This is not to say or intent that other handle methods and their application cannot be used on the invention or its embodiments where applicable.

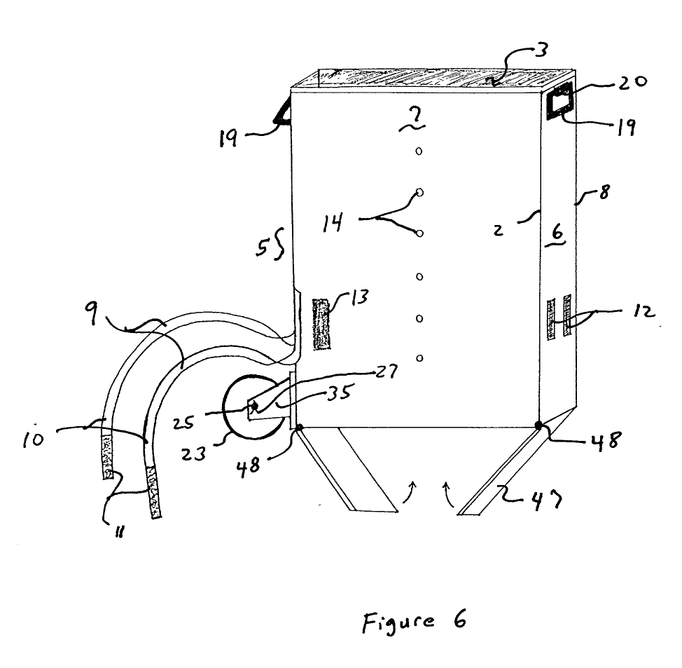

FIG. 2 shows the invention's wheel side or backside 5. The invention's wheels 23 roll on an axle 24. The axle 24 may have locking caps 26 to hold the wheels 23 in place. Washers 25 and cotter pins 27 may also be used to hold the wheels in place, as shown in FIG. 6. The axle 24 is held to the body 1 by molded plastic axle guides or supports 28. As shown in FIG. 5, the axle 24 may be replaced by snap on wheels 29 held to the body 1 by molded plastic snap on wheel retainers 34. On some of the embodiments, the wheels 23 may be held in place on the body 1 by wheel brackets 35, as shown in FIG. 6. This is not to say or intend that wheels of other designs and their application cannot be used on the invention and its various embodiments. Wheels 23 and axles 24 may not be shown on all embodiments but their placement and use are intended where applicable.

These features of the invention allow for a single user to make the inter-locking connections between the hooks 11 on the free ends 10 of the webbing cross straps 9 and the patches of loops 12 on the body's front side 6. The user may then insert a bag 22, provided by the user, into the interior of the body 1 of the invention, fold the top of bag 22 over the open top 3 and apply the elastic ring 15 over the bag and between the top lip 16 and the bottom lip 17 holding bag 22 in place. The user then can move the body 1 from location to location and fill bag 22, for example from one pile of leaves to another.

When the bag 22 is full, the user removes the elastic ring 15 from the body 1. The method of bag closure is left up to the user, such as tying the bag 22 closed or the use of twist ties or pull strings. Then, the user releases the connection of the hooks 11 on the two cross straps 9 and the two patches of loops 12 located on the body's front side 6. The user then makes the connection between the hooks 11 on the two cross straps 9 and the two patches of loops 13 located on the body's 1 right side 7 and its left side 8.

The user can then tilt and roll the body 1 by using the handle 19 on its wheel side 5 or lift the body 1 by using both handles 19 (or the second lower handles 101) and empty the body 1 of its contents at a desired location, such as, at the curb for trash pick up.

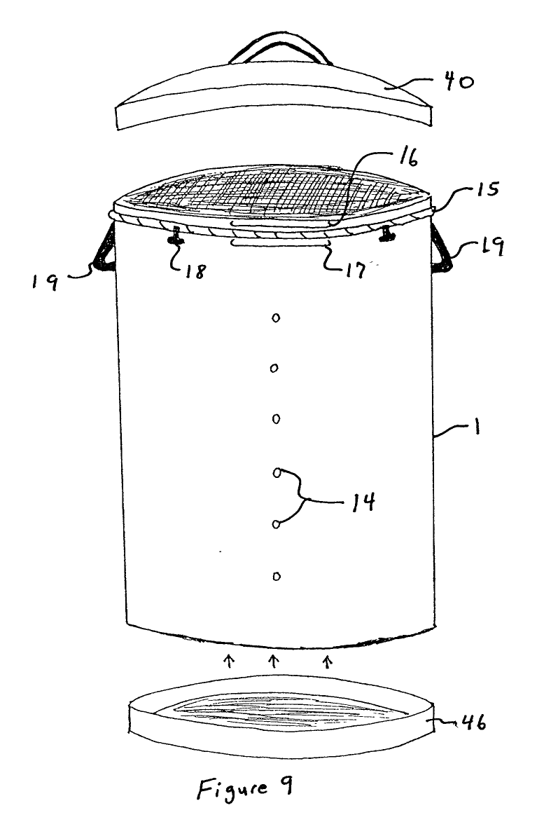

On alternate embodiments, it may be desired to have lids to cover the body's round open top 3. These tops may be round 40 in design, as shown in FIGS. 5 and 9, or square 41 in design, as shown in FIG. 8, depending on the design of the body they are intended to fit and cover.

In FIG. 5, this concept shows a round body 1 in design. It may have some of the features of the preferred embodiment such as handles 19, vent and exhaust holes 14, retaining ring 15, retaining lips 16 & 17 and wheels 23. A removable bottom cover or base 46 is held in place by the cross straps 9. The removable base 46 may be notched, as shown in FIG. 14, to define a gap 102 to accommodate the wheel brackets 35. The 53 removable base's inside diameter in this embodiment is slightly larger than the body's 1 outside diameter so that the body 1 will fit into the removable base 46. The body may also come in a square design 2. The removable base 46 may also be square in design to fit the square body 2.

FIG. 1 shows the base as being slightly smaller than the bottom 4 and extensions 104 above the bottom 4 keep the base 46 from going too far into the can.

In FIG. 6, a square body 2 is shown. It may have some of the features of the preferred embodiment such as handles 19, vent and exhaust holes 14, retaining ring 15 and retaining lips 16 & 17 and wheels 23. The webbing cross straps 9 are supplemented with two bottom plates 47 that are held by hinges 48 on the body's backside 5 and front side 6. These plates 47 are allowed to swing open or closed by the placement of the two cross straps 9 or their release as described in the same procedure as discussed in the preferred embodiment.

In FIG. 7, there is a round body 1. It may have some of the features of the preferred embodiment such as handles 19, vent and exhaust holes 14, retaining ring 15 and retaining lips 16 & 17 and wheels 23. The webbing cross straps 9 are replaced with a round swing out or in hinged bottom plate 49 held to the body by a hinge 50 and short elastic rubber straps 51 with a locking device 43 with finger tabs 44 attached to the hinged bottom plate 49. The locking devices 43 will fit into notched locking device receivers 45 molded onto the body 1. The user is able to empty the contents of the body 1 by releasing the rubber locking devices 43 from their receivers 45 by the use of the finger tabs 44 and swinging the hinged bottom plate 49 out of the way.

In FIG. 8, a square body 2 is shown. It may have some of the features of the preferred embodiment such as handles 19, vent and exhaust holes 14, retaining ring 15 and retaining lips 16 & 17 and wheels 23. The webbing cross straps 9 are replaced with a slide in and out plate 54 which is held in place by molded or metal slotted guides 55 in the body's lower interior. The user is able to empty the contents of the body by pulling the slide plate 54 from its guides 55.

In FIG. 9, a round body 1 is used. It may have some of the features of the preferred embodiment such as handles 19, vent and exhaust holes 14, retaining ring 15 and retaining lips 16 & 17. A removable base 46 is shown. The removable base's inside diameter is slightly larger than the body's 1 outside diameter so that the body 1 will fit into the removable base 46. The body may also come in a square design 2. The removable base 46 may also be square in design to fit the square body 2. The user is able to empty to the contents of the body 1 by lifting the body 1 approximately straight up, above and out of the attaching cylinder 46 and the body's contents such as a full plastic garbage bag 22. This embodiment would be very useful in areas such as lunch rooms, break rooms, etc. where large volumes of heavy garbage are accumulated. The user is only responsible for lifting the body 1 rather than lifting the heavy contents.

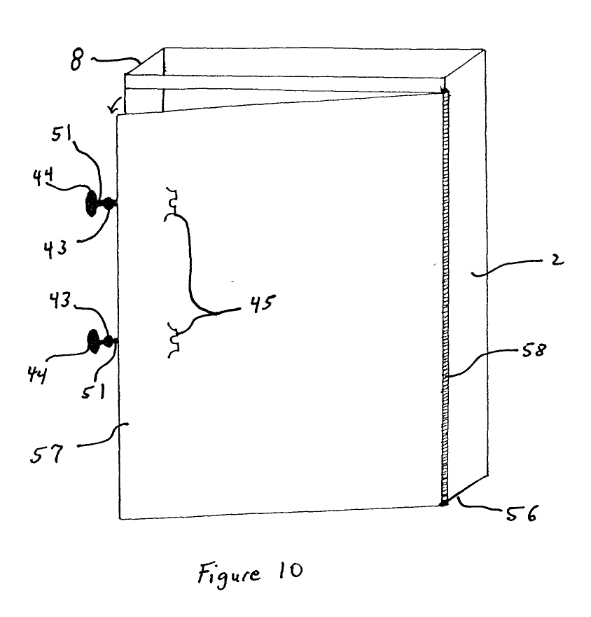

In FIG. 10, a square body 2 is shown. It may have some of the features of the preferred embodiment such as handles 19, vent and exhaust holes 14, retaining ring 15 and retaining lips 16 & 17 and wheels 23. The removable bottom concept is replaced by the concept of a permanent or fixed bottom 56 with a hinged door 57 on its front side 6, held in place to the body 1 by a hinge 58 and kept in a closed position by short elastic rubber retaining straps 51 with a rubber locking device 43 with finger tabs 44 attached to the body 1 that fit into notched locking device receivers 45 molded or fixed on its hinged door 57. The user is able to empty the contents of the body 1 by releasing the rubber locking devices 43 from their receivers 45 by use of the finger tabs 44 and opening the hinged door 57.

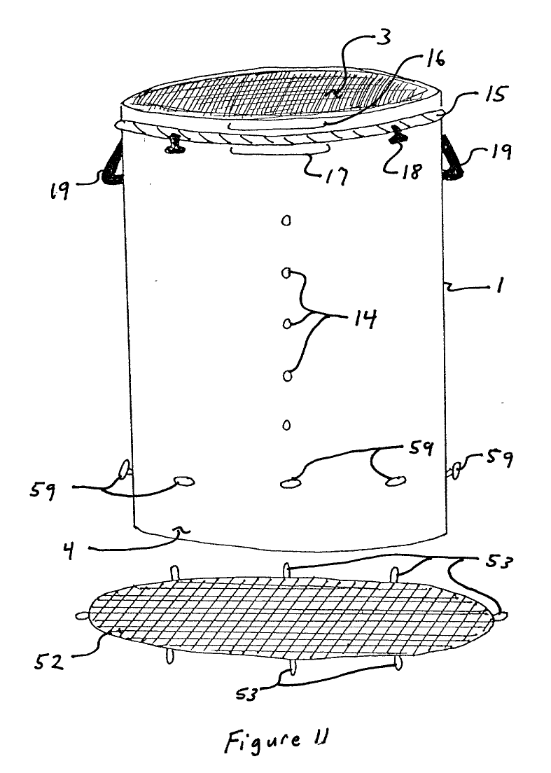

In FIG. 11, a round body I is shown. It may have some of the features of the preferred embodiment such as handles 19, vent and exhaust holes 14, retaining ring 15 and retaining lips 16 & 17 and wheels 23. The webbing cross straps 9 are replaced with a removable net 52 with holding loops 53 which is held in place to the body by molded “T” receivers 59 in which the net's holding loops 53 fit over. The user is able to empty the contents of the body 1 by removing the net's holding loops 53 from the molded “T” receivers 59 which releases the net 52 from the body 1. The body 1 may also come in a square design 2.

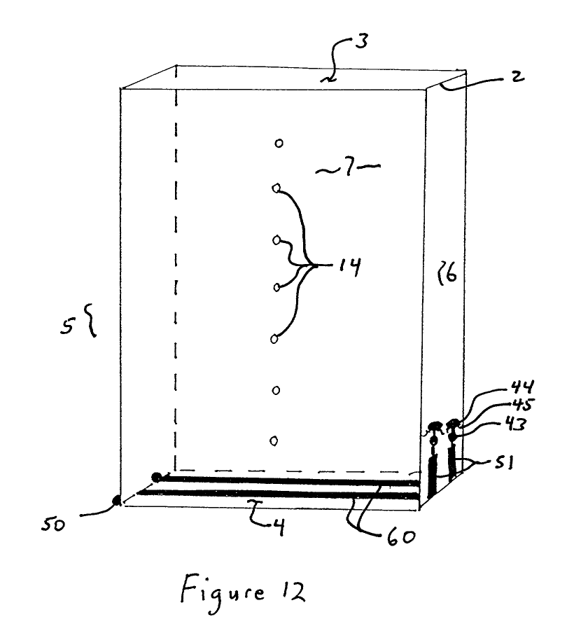

In FIG. 12, a square body 2 is shown. It may have some of the features of the preferred embodiment such as handles 19, vent and exhaust holes 14, retaining ring 15 and retaining lips 16 & 17 and wheels 23. The webbing cross straps 9 are replaced with two plastic forks 60. The forks 60 are held in place by hinges 50 on the body's backside 5 and short elastic retaining straps 51 on the body's front side 6. These short elastic straps 51 have locking devices 43 and finger tabs 44 on their free ends 10. The body 2 has notched locking device receivers 45 on its front side 6. The user is able to empty the contents of the body by releasing the locking devices 43 from their receivers 45 and moving a hinged fork 60 to the body's right side 7 and moving the other hinged fork 60 to the body's left side 8.

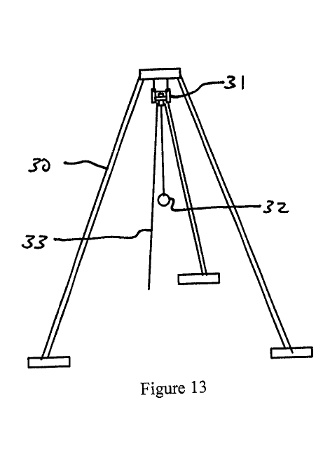

FIG. 13 shows a lifting device which consists of pole framework 30, a cable 33 from a hand running through a pulley 31 at the top of the pole framework 30 with loops or rings 32 at its end which attach to downward shaped hooked handles 39, as shown in FIG. 7.

FIGS. 14 and 1 show where strap buckles 105 defining slots 106 through which the straps 10 may pass and these keep the straps 10 in place. These buckles 105 may also elevate the base off the ground so air may pass in to holes 106 in the base.

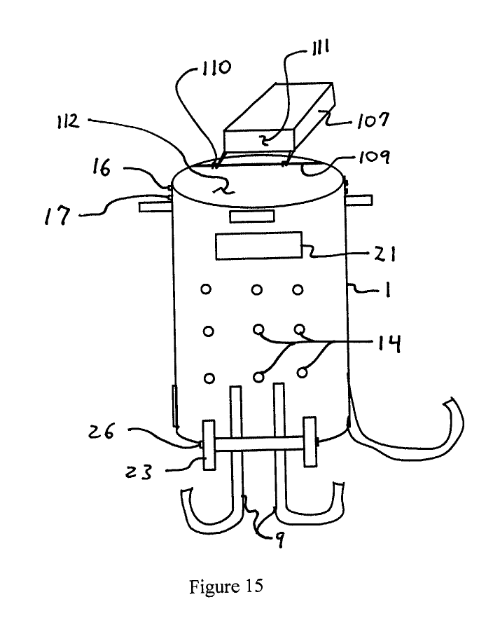

FIG. 15 shows a support 109 running across the opening 112 in the top of the body 1 to which clips 110 on rods 108 from a grass catcher 107 may be supported so that the opening 111 of the grass catcher 107 can be held over the opening 112 of the body so the catcher 103 can be shaken empty into the body 1 without the user supporting the full weight of the grass catcher. This type of catcher is commonly used on lawn mowers to catch grass. The rods 108 and clips 110 serve to hold the grass catcher 107 in place against an opening in the side or rear (most commonly) of the mower.

Because many varying and different embodiments may be made within the scope of the inventive concept herein taught and because many modifications may be made in the embodiment(s) herein detailed in accordance with the descriptive requirements of the law, it is to be understood that the details herein are to be interpreted a illustrative and not in a limiting sense.

1. A container for holding refuse within a bag comprising:
a) a container having a left side and a right side a front, a back a top and a bottom and defining an interior and further defining a top opening and a bottom opening, said bottom opening having an inside diameter and an outside diameter and wherein the inside diameter defines an inside perimeter and wherein the outside diameter defines an outside perimeter;
b) a bottom closing means releasably attached to the bottom for at least partially restricting the bottom opening;
c) a securing means for securing the bottom closing means in place at the bottom of the container.

2. The invention of claim 1 wherein the bottom closing means comprises a plate having a top a bottom and an outside diameter approximately equal to the inside diameter of the bottom opening.

3. The invention of claim 2 wherein the securing means comprises an extension running around at least a portion of the inside perimeter so as to prevent the plate from moving within the interior to a distance past the ridge.

4. The invention of claim 3 wherein the securing means further comprises at least one strap running between the back side and front container bottom so as to run beneath and secure the plate in place.

5. The invention of claim 1 wherein the bottom closing means comprises a solid plate having an outside perimeter and an outside diameter approximately equal to the outside diameter of the bottom opening and at least one upward extending wall running from the plate outside perimeter.

6. The invention of claim 5 wherein the securing means further comprises at least one strap running between the left side and right container bottom so as to run beneath and secure the plate in place.

7. The invention of claim 6 wherein the at least one strap is elastic.

8. The invention of claim 5 wherein the strap further comprises at least one first attachment means on the front side of the container for holding the at least one strap on the back side and at least one second attachment means for releasably holding the at least one strap to the front side of the container.

9. The invention of claim 6 wherein the plate bottom comprises at least one buckle defining a opening so that the at least one strap may pass through the buckle to secure the plate against the container bottom.

10. The invention of claim 1 wherein the container further comprises at least one wheel support bracket attached approximately at the bottom of the container and further comprising at least one wheel having a diameter attached to the at least one wheel support bracket.

11. The invention of claim 10 wherein the wheel diameter is sufficient large to provide a leverage arm for rotation of the container over the wheel to lift the container above at least a portion of refuse placed within the container.

12. The invention of claim 1 wherein the container further comprises at least one first lip means between the top and bottom of the container for receiving an elastic strap to secure a bag placed partially within the container with a top opening spread over the top of the container and below the at least one first lip.

13. The invention of claim 12 further comprising at least one second lip means between the at least one first lip means and the bottom of the container so that an elastic strap may be secured between the at least one first lip means and at least one second lip means.

14. The invention of claim 5 wherein the plate is further defined as defining at least one bracket opening and wherein the container further comprises at least one bracket extending from the bottom of the container so that bracket fits within the bracket opening.

15. The invention of claim 1 further comprising a plurality of openings along at least one of the left side, the right side, the front, the back and the bottom to allow air to move into or out of the interior.

16. The invention of claim 1 further comprising a plurality of ridges within the interior and running along at least one of the left side, the right side, the front, the back and the bottom to allow air to move into or out of the interior.

17. The invention of claim 1 further comprising at least one first set of handles located approximately at the top of the cylinder.

18. The invention of claim 17 further comprising at least one second set of handles located between the first set of handles and the bottom of the container to facilitate the lifting of the container from the ground.

19. The invention of claim 17 wherein the at least one first set of handles defines at least one hook and wherein the invention further comprises a lifting means having a support for holding the lifting means above the bottom of the container and a lifting line connectable to the at least one hook for lifting the container.

20. The invention of claim 8 wherein the container further comprises a second connecting means for securing the strap at a location where the strap does not pass below the plate.

21. The invention of claim 8 wherein the strap further comprises a fixed end and a free end and wherein the securing means further comprises at least one first part of a set of interlocking hooks and loops located on strap free end and further comprises on the front end a patch containing at least one second part of a set of the cooperating interlocking hooks and loops cooperating with the at least one first set.

22. The invention of claim 21 further comprising at least one second second part of a set of cooperating interlocking hooks and loops cooperating with the at least one first set located on the exterior of the container for securing the strap at a location where the strap does not pass below the plate.

23. The invention of claim 1 wherein the container defines an interior surface and exterior surface and wherein the top of the container is smaller than bottom of the container and wherein the container defines a gradual transition between the interior surface and exterior surface from the top to the bottom so that containers may be stacked.
